(19) United States
(12) Patent Application Publication
(10) Pub. No.: US 2018/0025379 A1
(43) Pub. Date: Jan. 25, 2018

(54) PREDICTING PERFORMANCE OF CONTENT ITEMS PRESENTED TO USERS OF AN ONLINE SYSTEM BASED ON CONTEXTS IN WHICH THE CONTENT ITEMS ARE PRESENTED TO THE USERS

(71) Applicant: Facebook, Inc., Menlo Park, CA (US)

(72) Inventors: Philip Adam Hewinson, Woking (GB); Adam Stevens, London (GB); Ben Parsons, London (GB); Anala Joelle Prabhu, London (GB); Maya Cahier, London (GB); Sebastian Michael Anthony Totte, London (GB)

(21) Appl. No.: 15/216,664

(22) Filed: Jul. 21, 2016

(51) Int. Cl. G06Q 30/02; H04L 29/08

(52) U.S. Cl. CPC G06Q 30/0244; H04L 67/20; G06Q 30/0251

(57) ABSTRACT

An online system determines a predicted performance of presenting a content item based on factors including a context in which the content item is to be presented. The context in which the content item is to be presented identifies other content presented in conjunction with the content item, content presented prior to presenting the content item, or actions performed prior to, after, or during presentation of the content item. Based on prior actions by users presented with content items in different contexts, the online system determines a quality score for each context. Using the quality score for the context in which the content item is to be presented and other factors, the online system determines the predicted performance of presenting the content item. The online system may modify determination of the predicted performance as the online system receives information describing results of presenting the content item.

### BACKGROUND

This invention relates generally to presenting content to users of an online system, and more specifically to predicting performance of content presented to users.

Various online systems receive content from users or third party systems and provide the received content to online system users. An online system may select content for presentation to a user based on information about the user maintained by the online system. For example, an online system allows a user to establish connections between other users and to provide content to the online system, which provides the content to the other users connected to the user. The increasing popularity of online systems, and the significant amount of user-specific information maintained by online systems, allow users of an online system allows to easily communicate information about themselves to other users and share content with other users.

Additionally, entities may sponsor presentation of content items via an online system to gain public attention for the entity's products or services, or to persuade online system users to take an action regarding the entity's products or services. Many online systems receive compensation from an entity for presenting online system users with certain types of sponsored content items provided by the entity. Frequently, online systems charge an entity for each presentation of sponsored content to an online system user (e.g., each “impression” of the sponsored content) or for each interaction with sponsored content by an online system user (e.g., each “conversion”). For example, an online system receives compensation from an entity each time a content item provided by the entity is displayed to a user on the online system or each time a user is presented with a content item on the online system and the user interacts with the content item (e.g., requests additional content by interacting with the content item).

When presenting content to users, an online system may present content items in different contexts. For example, the online system selects content for presentation to users for presentation by the online system itself, for presentation by an application, or for presentation by a third party system other than the online system. Additionally, a content item selected for presentation to a user by an online system may be presented in different ways. For example, if an application presents the content item selected by the online system, the application may present the content item based on different user interactions with the application or based on different content that the application presented to the user prior to presenting the content item or content that the application will present to the user after presenting the content item. A context in which a content item is presented by the online system, by an application, or by a third party system affects a likelihood of a user to whom the content item is presented interacting with the content item. However, conventional online systems are unable to accurately evaluate how contexts in which a content item is presented to users influence interaction with the content item. This may reduce revenue obtained by the online system from interactions with content items and decrease future opportunities for the online system to obtain revenue from third party systems or other sources subsequently using the online system to select or to present content to users.

### SUMMARY

An online system maintains multiple content items for presentation to users. Content items may be obtained from users of the online system, third party systems, or generated by the online system. The online system presents content items to users via the online system, and may also provide content items to third party systems or to applications for presentation to users of the online system. To evaluate user interaction or engagement with a content item when the content item is presented, the online system identifies a context in which the content item is to be presented and determines a score for the content item bases at least in part on the context in which the content item is to be presented. Accordingly, the online system maintains information describing contexts in which content items were presented relative to other content presented to the users of the online system. The context in which a content item is presented, or in which the content item is to be presented, identifies one or more of: other content presented before presentation of the content item, actions performed by a user prior to presentation of the content item, content presented in conjunction with the content item, and an application presenting the content item. For example, the online system associates an identifier of an application that presented a content item and information describing other content presented in conjunction with the application with an identifier of the content item. As another example, the online system associates information indicating a content item was presented in a display shown when a client device is in a locked state with an identifier of the content item.

In some embodiments, the online system associates different sets of contexts in which a content item was presented with different applications. For example, the online system stores a set of contexts in which a content item was presented in association with an identifier of an application to identify the contexts in which the application corresponding to the application identifier is capable of presenting content. As certain contexts may apply to certain applications and not to other applications, associating sets of contexts with identifiers of different applications allows the online system to more efficiently identify contexts for presenting a content item after determining an application in which the content item was presented or in which the content item is to be presented.

The online system determines a quality score for each of at least a set of contexts in which content items were presented based on prior interactions with content items by online system users. In some embodiments, the online system determines a quality score for each context in which content items were presented. The quality score for a context is a numeric value describing effectiveness of the context in causing users to perform one or more particular actions after being presented with a content item in the context. To determine the quality score for a context, the online system identifies content items that were previously presented to online system users in the context (e.g., content items presented to online system users in the context within a threshold time from a current time, content items presented to online system users in a specified time interval, etc.). The online system determines one or more particular actions performed by users after the users were presented by a content item in the context and determines the quality score for the context based on the number or frequency of the particular actions (e.g., installation of an application associated with the content item, accessing content associated with the content item, indicating a preference for the content item, sharing the content item with another user, purchasing a product or a service associated with the content item, establishing an account with a third party system associated with the content item, etc.) performed by users after being presented with a content item in the context. In some embodiments, the online system determines a ratio of a number of times users presented with a content item in the context performed a particular action to the number of times the content item was presented to users in the context during a time interval and determines the quality score by combining ratios determined for different content items presented in the context. For example, the online system determines a ratio of a number of times users presented with a content item in the context performed a particular action specified by the content item within a threshold amount of time after being presented with the content item to a number of times the content item was presented in the context during a time interval and determines the quality score for the context as a combination of ratios determined for various content items presented in the context. The online system determines and stores a quality score for each of at least a set of contexts in which content items were presented.

In various embodiments, a user providing a content item to the online system specifies a context in which to present the content item to the online system. As a context may provide an indication of a mindset of another user to whom the content item is presented, specifying the context allows the user providing the content item to identify a context in which to present the content item so another user to whom the content item has a mindset that may increase a likelihood of the other user accessing or interacting with the content item. For example, the content item includes a description or an identifier of the context in which the content item is to be presented. Alternatively, the online system applies one or more models to a content item that determine a context in which the content item is to be presented. For example, a model determines likelihoods of the content item being presented in various contexts, and the online system identifies the context having a maximum likelihood as the context in which the content item is to be presented. In other embodiments, one or more users of the online system, such as administrators of the online system, identify a context in which to present the content item by reviewing the content item. Alternatively, a third party system associated with an application in which content items are presented identifies contexts in which the application presents content items. If the content item was previously presented by an application via instructions provided to the application by the online system (e.g., a software development kit provided to the application by the online system), when the content item was presented, the application executed one or more instructions that communicated information identifying a context in which the application presented the content item; accordingly, the online system identifies the received context in which the content item was presented by the application.

When the online system obtains a content item and identifies a context in which to present the content item, the online system retrieves a quality score associated with the identified context in which to present the content item and predicts a performance of the content item based on the quality score associated with the identified context and one or more characteristics of the content item. In various embodiments, the content item identifies different locations (e.g., countries, states, cities) in which the content item is to be presented, and the online system determines a predicted performance of the content item based on the quality score associated with the identified content in which to present the content item and a value based on the different locations. For example, the online system determines the predicted performance of the content item as a product of a value based on a location in which the content item is to be presented and a constant raised to a power of the quality score for the context in which the content item is to be presented. In a specific example, the predicted performance is a product of a percentage of presentations of the content item in a particular location and two raised to the power of the quality score for the context in which the content item is to be presented. The predicted performance of the content item presented in the context is a predicted revenue from presenting the content item in the context to users in a particular location in some embodiments. For example, the online system determines a ratio of a number of times the content item is presented in a day to a constant (e.g., 1000) and determines a predicted revenue from presenting the content item to users in the particular location as a product of a percentage of presentations of the content item in a particular location, the determined ratio, a conversion factor identifying revenue received per presentation of the content item, and two raised to the power of the quality score for the context in which the content item is to be presented. In some embodiments, the online system determines a predicted total revenue of the content item by combining predicted revenues from presenting the content item to users in various particular locations determined as described above. Hence, the predicted performance of the content item allows the online system to account for likelihoods of users interacting with the content item by accounting for users' likelihood of interacting with the content item based on a mindset of the users inferred from or associated with the context.

The online system may identify the predicted performance to a user who provided the content item to the online system, allowing the user to modify one or more characteristics of the content item based on the predicted performance. Additionally, when the content item is presented to users, the online system compares performance of the content item to the predicted performance of the content item. For example, the online system determines revenue obtained from presenting the content item to users in a location in a context and compares the obtained revenue to the predicted revenue from presenting the content item to users in the location in the context. In response to the comparison indicating at least a threshold difference between the obtained revenue and the predicted revenue, the online system modifies the context in which the content item is to be presented used to predict revenue from presenting the content. Alternatively, if the comparison indicates at least the threshold difference between the obtained revenue and the predicted revenue, the online system modifies a method used by the online system to predict performance of the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for predicting performance of a content item based on a context in which the content item is to be presented to users of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

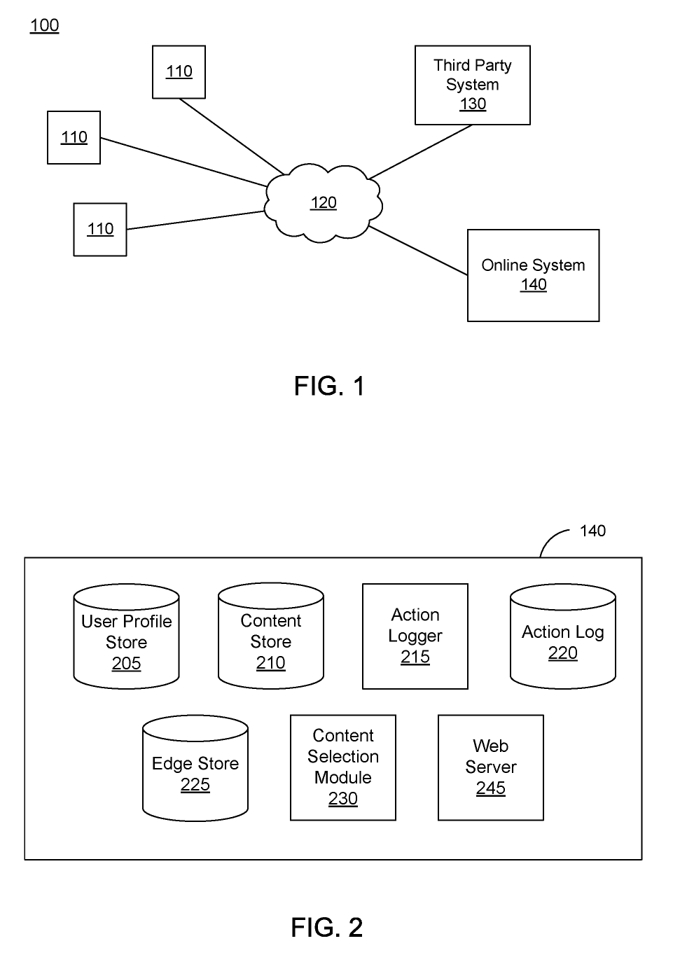

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also includes a landing page specifying a network address to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

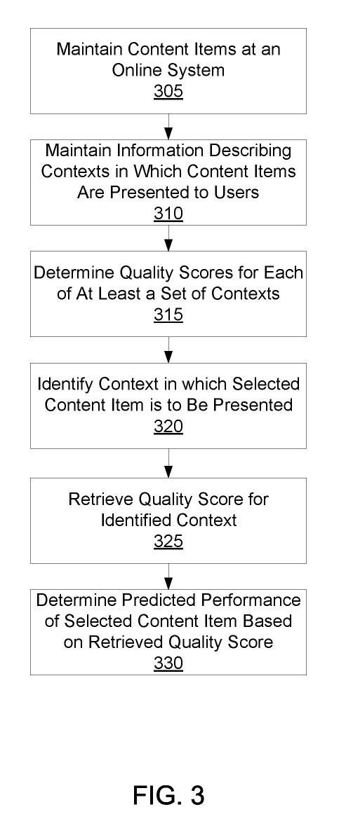

In various embodiments, the content store 210 also stores information associated with various content items identifying contexts in which content items were presented to users or in which content items are to be presented to users. The context in which a content item is presented, or in which the content item is to be presented, identifies one or more of: other content presented before presentation of the content item, actions performed by a user prior to presentation of the content item, content presented in conjunction with the content item, and an application presenting the content item. In various embodiments, the online system 140 maintains various contexts in which a content item is presented, or is to be presented, to categorize presentation of various content items. For example, a context in which a content item is to be presented, or was presented, indicates if the content item is to be presented after a user performs an action, prior to a user performing an action, when a user performs an action (e.g., is playing a game, provides a specific input to an application), when identified other content is also presented, if the content item is presented in a particular format (e.g., as a message to a user, as a notification sent to a client device 110 for presentation to the user, etc.). As further described below in conjunction with FIG. 3, the online system 140 may identify a context in which a content item is to be presented based on information included in the content item, application of one or more models to characteristics of the content item, information identifying a context in which an application presented the content item, or manual evaluation of the content item. Further, different contexts may be associated with different applications that present content from the online system 140 in some embodiments.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, content items that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various ad requests (or other content items) based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The content selection module 230 may also determine a predicted performance of a content item received by the online system 140 based on a context in which the content item is to be presented. For example, the content selection module 230 maintains quality scores for various contexts. A quality score for a context describes an effectiveness of presenting content in the context in causing actions by users presented with the content in the context. As further described below in conjunction with FIG. 3, the context selection module 230 may determine the quality score for a context based on information from the content store 210 and the action log 220 identifying content items presented to users in the context and actions performed by users after being presented with the content items in the context.

To determine a predicted performance of a content item, the content selection module 230 identifies a context in which the content item is to be presented and determines the predicted performance of the content item based on the quality score for the identified context. As further described below in conjunction with FIG. 3, the content selection module 230 may identify the context in which the content item is to be presented based on information in the content item specifying the context, by applying one or more models to characteristics of the content item, or by manual review of the content item by an administrator of the content item. Determination of a predicted performance of a content item based on the quality score of an identified context in which the content item is to be presented is further described below in conjunction with FIG. 3. For example, the content selection module 230 determines the predicted performance of the content item based on a product of a percentage of presentations of the content item in a location (e.g., in a country) and a constant raised to a power of the quality score for the identified context.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Determining Predicted Performance of a Content Item Based on Context in which the Content Item is Presented to Users

FIG. 3 is a flowchart of one embodiment of a method for determining predicted performance of a content item based on a context in which the content item is to be presented to online system users. In some embodiments, the method may include different and or additional steps than those described in conjunction with FIG. 3. Additionally, in various embodiments, steps of the method may be performed in different orders than the order described in conjunction with FIG. 3.

An online system 140 maintains 305 multiple content items. Content items may be obtained from users of the online system 140 or from third party systems 130 that communicate with the online system 140. Additionally, the online system 140 may obtain various content items based on information accessible to the online system 140. As further described above in conjunction with FIG. 2, the online system 140 presents content items to its users. For example, the online system 140 selects content items for presentation to users and communicates selected content items to client devices 110 for presentation to the users. As another example, the online system 140 communicates content items to a third party system 130 or to an application, and the third party system 130 or the application presents the content items to users.

User interaction with the online system 140 or revenue obtained by the online system 140 is affected by user interaction with content items that the online system 140 identifies for presentation to users. For example, a content item includes a bid amount specifying an amount of compensation the online system 140 receives from a user who provided the content item to the online system 140 in exchange for other users viewing the content item or in exchange for other users performing an action after being presented with the content item (e.g., accessing the content item, purchasing a good or a service after being presented with the content item, etc.). User engagement with a content item is affected by a context in which the content item is presented, so presenting the content item in different contexts affects an amount of user engagement with the content item (e.g., a likelihood of the user performing an action after being presented with the content item).

Accordingly, the online system 140 maintains 310 information describing contexts in which content items are presented, or are to be presented. The context in which a content item is presented, or in which the content item is to be presented, identifies one or more of: other content presented before presentation of the content item, actions performed by a user prior to presentation of the content item, content presented in conjunction with the content item, and an application presenting the content item. In various embodiments, the online system 140 maintains various contexts in which a content item is presented, or is to be presented, to categorize presentation of various content items. For example, a context in which a content item is to be presented, or was presented, indicates if the content item is to be presented after a user performs an action, prior to a user performing an action, when a user performs an action (e.g., is playing a game, provides a specific input to an application), when identified other content is also presented, if the content item is presented in a particular format (e.g., as a message to a user, as a notification sent to a client device 110 for presentation to the user, etc.).

In some embodiments, the online system 140 maintains associations between different sets of contexts in which a content item was presented or is to be presented and different applications. For example, the online system 140 stores a set of contexts in which a content item was presented by an application in association with an identifier of the application, identifying contexts in which the application corresponding to the identifier of the application is capable of presenting content. As certain contexts may apply to certain applications and not to other applications, associating sets of contexts with identifiers of different applications allows the online system 140 to more efficiently identify contexts in which a content item is to be presented or in which a content item was presented by determining an application in which the content item was presented or in which the content item is to be presented and selecting from the set of contexts associated with the determined application.

The online system 140 determines 315 a quality score for each of at least a set of contexts in which content items were presented based on prior interactions with content items by online system users. In some embodiments, the online system 140 determines 315 a quality score for each context in which content items were presented. The quality score for a context is a numeric value describing effectiveness of the context in causing users to perform one or more particular actions after being presented with a content item in the context. In various embodiments, the quality score for a context has a numeric value within a specified range (e.g., a numeric value between one and five). To determine 315 the quality score for a context, the online system 140 identifies content items that were previously presented to online system users in the context (e.g., content items presented to online system users in the context within a threshold time from a current time, content items presented to online system users in a specified time interval, etc.) and determines one or more particular actions performed by users after the users were presented by a content item in the context. By applying one or more models (e.g., machine learned models) to the number or the frequency of the particular actions (e.g., installation of an application associated with the content item, accessing content associated with the content item, indicating a preference for the content item, sharing the content item with another online system user, purchasing a product or a service associated with the content item, establishing an account with a third party system 130 associated with the content item, etc.), the online system 140 determines 315 a quality score for the context performed by users after being presented with a content item in the context. In some embodiments, the online system 140 determines a ratio of a number of times users presented with a content item in the context performed a particular action to the number of times the content item was presented to users in the context during a time interval and determines 315 the quality score applying one or more models that combine ratios determined for different content items presented in the context. For example, the online system 140 determines a ratio of a number of times users presented with a content item in the context performed a particular action specified by the content item within a threshold amount of time after being presented with the content item to a number of times the content item was presented in the context during a time interval and determines 315 the quality score for the context as a combination of ratios determined for various content items presented in the context. The online system 140 determines 315 and stores a quality score for each of at least a set of contexts in which content items were presented, and may determine 315 and store a quality score for each context in which content items were presented.

To evaluate user interaction or engagement a content item, the online system 140 selects a content item from the maintained content items and identifies 320 a context in which the selected content item is to be presented. In various embodiments, a user providing the selected content item to the online system 140 specifies a context in which to present the selected content item to the online system 140, and the online system 140 identifies 320 the context in which the selected content item is to be presented from the user-provided information. For example, the selected content item includes a description or an identifier of the context in which the content item is to be presented, so the online system 140 determines 320 the context in which the selected content item is to be presented from the description or identifier included in the selected content item. Alternatively, the online system 140 applies one or more models to the selected content item to identify 320 the context in which the selected content item is to be presented. For example, a model determines likelihoods of the selected content item being presented in various contexts, and the online system 140 identifies 320 the context having a maximum likelihood as the context in which the selected content item is to be presented. In other embodiments, one or more users of the online system 140, such as administrators of the online system 140, identify 320 the context in which to present the selected content item by reviewing the content item. Alternatively, a third party system 130 associated with an application in which content items are presented identifies contexts in which the application presents content items. If the content item was previously presented by an application via instructions provided to the application by the online system 140 (e.g., a software development kit provided to the application by the online system 140), when the application presented the selected content item, the application executed one or more instructions that communicated information identifying a context in which the selected content item was presented. Hence, the online system 140 identifies 320 the received context in which the content item was presented by the application from the information communicated to the online system 140 by the application.

The online system 140 retrieves 325 a quality score for the identified context in which the selected content item is to be presented and determines 330 a predicted performance of the selected content item based on the quality score associated with the identified context and one or more characteristics of the content item. In various embodiments, the content item identifies different locations (e.g., countries, states, cities) in which the content item is to be presented, and the online system 140 determines 330 the predicted performance of the content item based on the quality score associated with the identified content in which to present the content item and a value based on the different locations. For example, the online system 140 determines 330 the predicted performance of the content item as a product of a value based on a location in which the content item is to be presented and a constant raised to a power of the quality score for the context in which the content item is to be presented. In a specific example, the predicted performance is determined 330 as a product of a percentage of presentations of the content item in a particular location and two raised to the power of the quality score for the context in which the content item is to be presented.

The predicted performance of the content item presented in the context may be a predicted revenue generated from presenting the content item in the context to users in a particular location in some embodiments. For example, if the selected content item includes a bid amount specifying an amount of compensation the online system 140 receives for user actions after being presented with the selected content item or for presenting the selected content item to users. The online system 140 may determine a ratio of a number of times the selected content item is presented in a day to a presentation constant (e.g., 1000) and determine 330 a predicted revenue from presenting the content item to users in a location (e.g., in a particular country) as a product of a percentage of presentations of the content item in the location, the determined ratio, a conversion factor identifying a revenue from presentation of the selected content item, and two raised to the power of the quality score for the context in which the content item is to be presented. The conversion factor may be based on the bid amount included in the selected content item and likelihoods of users in the location viewing the selected content item or performing interactions after being presented with the selected content item. In some embodiments, the online system 140 determines 330 a predicted total revenue of the selected content item by combining predicted revenues from presenting the content item to users in various locations determined as described above.

In various embodiments, the online system 140 may use other factors to determine 330 the predicted performance of the selected content item. For example, values based on a season or a time when the selected content item is to be presented are also used with the quality score for the identified context to determine 330 the predicted performance of the selected content item. Various other factors may be used by the online system 140 in other embodiments, however.

The online system 140 may identify the determined predicted performance of the selected content item to a user who provided the content item to the online system 140, allowing the user to modify one or more characteristics of the content item based on the predicted performance. For example, the user modifies the context in which the selected content item is to be presented based on the determined predicted performance, allowing the user to specify a context for presenting the selected content item to maximize or to optimize predicted performance of the selected content item. If the online system 140 identifies 320 the context in which the selected content item is to be presented by applying one or more models to characteristics of the selected content item, the online system 140 may determine 330 predicted performances of the selected content item for different potential contexts (e.g., for contexts that in which the one or more models determine at least a threshold likelihood of the selected content item being presented), allowing the user who provided the selected content item to the online system 140 to evaluate how presenting the selected content item in different contexts would affect performance of the content item. In another example, the online system 140 determines 330 predicted performances of the selected content item for a set of contexts specified in the selected content item or identified by administrators of the selected content item based on characteristics of the selected content item.

Additionally, when the selected content item is presented to online system users, the online system 140 compares performance of the selected content item to the predicted performance of the selected content item. For example, the online system 140 determines revenue obtained from presenting the selected content item to users in a location in the identified context and compares the obtained revenue to the predicted revenue from presenting the selected content item to users in the location in the identified context. In response to the comparison indicating at least a threshold difference between the obtained revenue and the predicted revenue, the online system 140 identifies an alternate context in which the content item is to be presented used to predict revenue from presenting the selected content item and determines 330 a predicted performance of the selected content item bases on the alternate context. Alternatively, if the comparison indicates at least the threshold difference between the obtained revenue and the predicted revenue, the online system 140 modifies a method used to predict performance of the selected content item when presented in the identified context. For example, the online system 130 modifies the conversion factor identifying a revenue from presentation of the selected content item if the obtained revenue differs from the predicted revenue by greater than the threshold difference.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining one or more content items at an online system for presentation to users of the online system;
maintaining information at the online system describing contexts in which content items are presented to users of the online system, a context in which a content item is presented to a user identifying one or more of: content presented in conjunction with the content item, content presented prior to presentation of the content item, an action performed by a user prior to presentation of the content item, and any combination thereof;
determining a quality score for each of at least a set of contexts in which content items are presented to users of the online system, the quality score for a context based on actions performed by users of the online system who were previously presented with one or more content items in the context;
identifying a context in which a selected content item is to be presented to users of the online system;
retrieving a quality score for the identified context; and
determining a predicted performance of the content item based the retrieved quality score for the identified context and one or more characteristics of the selected content item.

2. The method of claim 1, wherein determining the predicted performance of the content item based the retrieved quality score for the identified context and one or more characteristics of the selected content item comprises:
determining the predicted performance of the selected content item as a product of a percentage of presentations of the selected content item in a particular location and a constant raised to a power of the quality score of the identified context.

3. The method of claim 2, wherein the constant is two.

4. The method of claim 1, wherein the selected content item includes a bid amount

5. The method of claim 4, wherein determining the predicted performance of the content item based the retrieved quality score for the identified context and one or more characteristics of the selected content item comprises:
determining the predicted performance of the selected content item as a product of a percentage of presentations of the selected content item in a particular location and a constant raised to a power of the quality score of the identified context, and a conversion factor based on the bid amount included in the selected content item and likelihoods of users in the location viewing the selected content item or performing interactions after being presented with the selected content item.

6. The method of claim 5, wherein determining the predicted performance of the content item based the retrieved quality score for the identified context and one or more characteristics of the selected content item comprises:
determining the predicted performance of the selected content item as a product of the percentage of presentations of the selected content item in a particular location, the constant raised to the power of the quality score of the identified context, and a conversion factor based on the bid amount included in the selected content item and likelihoods of users in the location viewing the selected content item or performing interactions after being presented with the selected content item, and a ratio of a number of presentations of the content item during an interval to a presentation constant.

7. The method of claim 1, further comprising:
presenting the selected content item to users of the online system;
determining performance of the selected content item from information received after presentation of the selected content item to users of the online system;
comparing the predicted performance of the content item to the determined performance of the selected content item; and
identifying an alternate context in which the selected content item is to be presented in response to the comparison indicating greater than a threshold difference between the predicted performance of the content item and the selected content item.

8. The method of claim 7, further comprising:
determining a predicted performance of the selected content item based on a quality score for the alternate context.

9. The method of claim 1, wherein the context in which the content item is presented to the user identifies one or more selected from a group consisting of: if the content item is to be presented after a user performs an action, if the content item is to be presented prior to a user performing the action, if the content item is to be presented when a user performs the action, other content presented when the content item is also presented, if the content item is presented in a particular format, and any combination thereof.

10. The method of claim 1, wherein maintaining information at the online system describing contexts in which content items are presented to users of the online system comprises:
maintaining identifiers of applications that present content items provided by the online system;
maintaining a set of contexts associated with each identifier, the set of contexts associated with an identifier specifying contexts in which an application corresponding to the identifier presented one or more content items.

11. The method of claim 1, wherein identifying the context in which the selected content item is to be presented to users of the online system comprises:
identifying the context as a context identified by information received by an application identifying a context in which the application presented the selected content item.

12. The method of claim 1, wherein identifying the context in which the selected content item is to be presented to users of the online system comprises:
applying one or more models to characteristics of the selected content item to determine likelihoods of the selected content item being presented in different contexts; and
identifying the context in which the selected content item is to be presented to users of the online system based on the determined likelihoods.

13. A computer program product comprising a computer-readable storage medium having instructions encoded thereon that, when executed by a processor, cause the processor to:
obtain one or more content items at an online system for presentation to users of the online system;
maintain information at the online system describing contexts in which content items are presented to users of the online system, a context in which a content item is presented to a user identifying one or more of: content presented in conjunction with the content item, content presented prior to presentation of the content item, an action performed by a user prior to presentation of the content item, and any combination thereof;
determine a quality score for each of at least a set of contexts in which content items are presented to users of the online system, the quality score for a context based on actions performed by users of the online system who were previously presented with one or more content items in the context;
identify a context in which a selected content item is to be presented to users of the online system;
retrieve a quality score for the identified context; and
determine a predicted performance of the content item based the retrieved quality score for the identified context and one or more characteristics of the selected content item.

14. The computer program product of claim 13, wherein determine the predicted performance of the content item based the retrieved quality score for the identified context and one or more characteristics of the selected content item comprises:
determine the predicted performance of the selected content item as a product of a percentage of presentations of the selected content item in a particular location and a constant raised to a power of the quality score of the identified context.

15. The computer program product of claim 13, wherein the selected content item includes a bid amount

16. The computer program product of claim 15, wherein determine the predicted performance of the content item based the retrieved quality score for the identified context and one or more characteristics of the selected content item comprises:
determine the predicted performance of the selected content item as a product of a percentage of presentations of the selected content item in a particular location, a constant raised to a power of the quality score of the identified context, and a conversion factor based on the bid amount included in the selected content item and likelihoods of users in the location viewing the selected content item or performing interactions after being presented with the selected content item, and a ratio of a number of presentations of the content item during an interval to a presentation constant.

17. The computer program product of claim 13, wherein the computer readable storage medium further has instructions encoded thereon that, when executed by the processor, cause the processor to:
present the selected content item to users of the online system;
determine performance of the selected content item from information received after presentation of the selected content item to users of the online system;
compare the predicted performance of the content item to the determined performance of the selected content item; and
identify an alternate context in which the selected content item is to be presented in response to the comparison indicating greater than a threshold difference between the predicted performance of the content item and the selected content item.

18. The computer program product of claim 17, wherein the computer readable storage medium further has instructions encoded thereon that, when executed by the processor, cause the processor to:
determine a predicted performance of the selected content item based on a quality score for the alternate context.

19. The computer program product of claim 13, wherein the context in which the content item is presented to the user identifies one or more selected from a group consisting of: if the content item is to be presented after a user performs an action, if the content item is to be presented prior to a user performing the action, if the content item is to be presented when a user performs the action, other content presented when the content item is also presented, if the content item is presented in a particular format, and any combination thereof.

20. The computer program product of claim 17, wherein identify the context in which the selected content item is to be presented to users of the online system comprises:
identify the context as a context identified by information received by an application identifying a context in which the application presented the selected content item.
